(19) United States
(12) Patent Application Publication
(10) Pub. No.: US 2016/0153420 A1
(43) Pub. Date: Jun. 2, 2016

(54) CONTROLLING COMBUSTION IN PLASMA IGNITION ENGINE

(71) Applicant: Caterpillar Inc., Peoria, IL (US)

(72) Inventors: Arnold M. Kim, Peoria, IL (US); James M. Schultz, Chillicothe, IL (US)

(73) Assignee: Caterpillar Inc., Peoria, IL (US)

(21) Appl. No.: 15/018,891

(22) Filed: Feb. 9, 2016

(51) Int. Cl. F02P 5/153; F02D 35/02; F02P 23/04

(52) U.S. Cl. CPC F02P 5/153; F02P 23/04; F02D 35/023

(57) ABSTRACT

A method for controlling combustion in plasma ignition engine is provided. The method includes receiving a signal indicative of a cylinder pressure, determining a location of predefined MBF and COV of IMEP based on the cylinder pressure, and comparing the determined location of predefined MBF with a target location of predefined MBF and the determined COV of IMEP with a target COV of IMEP. When the determined location of predefined MBF has note reached the target location of predefined MBF and the determined COV of IMEP is not less than the target COV of IMEP, the method includes steps to either vary characteristics, such as number of pulses, input voltage, distance between two subsequent pulses, of a plasma shock wave or advance a plasma spark timing. The plasma shock wave is of an order of nanometer.

### TECHNICAL FIELD

The present disclosure relates to a plasma ignition engine and more particularly to controlling combustion in the plasma ignition engine.

### BACKGROUND

With the development of technology, engines have evolved from a spark ignition and compression ignition engines to plasma ignition engines. The plasma ignition engine is developed to obtain reliable ignition and to improve reliability of fuel combustion under various engine operating conditions. The plasma ignition engine includes a plasma jet spark plug having a plasma jet cavity which can produce a plasma spark. When a sufficient amount of electrical energy is delivered to the plasma cavity, the plasma spark is generated to travel momentarily from the plasma cavity for combusting a compressed charge in the plasma ignition engine. The plasma spark includes free electrons and ions that are highly energetic and chemically active, which are responsible for the start of combustion.

In order to optimize the plasma spark, certain factors, such as applied electrical energy, volume of the plasma cavity, pressure in the plasma cavity, which can influence the initiation of the plasma spark from a plasma spark plug, are considered. However, increase in applied electrical energy could erode the plasma spark plug, thereby decreasing life of the plasma spark plug. Accordingly, the initiation of plasma spark may need to be based on parameters of the plasma ignition engine, such as load, operating pressures, and indicated mean effective pressure.

U.S. Pat. No. 8,428,848, hereinafter referred to as the '848 patent, describes a combustion control system for a direct injection engine. The combustion control system includes a mean effective pressure (MEP) determination module, a coefficient of variation (COV) determination module, a spark timing module, and a fuel control module. The MEP determination module determines a MEP for a first combustion event of a cylinder based on cylinder pressure measured by a cylinder pressure sensor during the first combustion event. The COV determination module determines a COV for the cylinder based on the MEP. The spark timing module sets spark timing for a second combustion event of the cylinder based on the COV. However, the '848 patent fails to disclose controlling initiation of plasma spark and control of the combustion of the charge in the plasma ignition engine.

### SUMMARY OF THE DISCLOSURE

According to an aspect of the present disclosure, a method for controlling combustion in a plasma ignition engine is provided. The method includes receiving, from a sensing unit, a signal indicative of a cylinder pressure. The sensing unit is disposed in the plasma ignition engine. The method further includes determining, by a control unit, a location of predefined mass burnt fraction (MBF) and co-efficient of variance (COV) of indicated mean effective pressure (IMEP), based on the cylinder pressure. The method further includes comparing, by the control unit, the determined location of predefined MBF with a target location of predefined MBF and the determined COV of IMEP with a target COV of IMEP. The method further includes determining whether number of pulses in a plasma shock wave is greater than a threshold number of pulses, when the determined location of predefined MBF has not reached the target location of predefined MBF and the determined COV of IMEP is not less than the target COV of IMEP. The method further includes receiving, from the sensing unit, the cylinder pressure from a subsequent operation cycle, when the determined location of predefined MBF has reached target location of predefined MBF and the determined COV of IMEP is less than the target COV of IMEP. The method further includes determining whether an input voltage associated with the plasma shock wave is greater than a predefined minimum voltage, when the number of pulses in the plasma shock wave is greater than the threshold number of pulses. The method further includes increasing the number of pulses in the plasma shock wave, when the number of pulses is less than the threshold number of pulses, to determine whether the location of predefined MBF has reached the target location of predefined MBF and the COV of IMEP is less than the target COV of IMEP. The method further includes determining whether a distance between two subsequent pulses is less than a predefined minimum distance, when the input voltage associated with the plasma shock wave is greater than the predefined minimum voltage. The method further includes increasing the input voltage associated with the plasma shock wave, when the input voltage is less than the predefined minimum voltage, to determine whether the location of predefined MBF has reached the target location of predefined MBF and the COV of IMEP is less than the target COV of IMEP. The method further includes determining whether a plasma spark time is greater than a predefined maximum plasma spark time, when the distance between two subsequent pulses is less than the predefined minimum distance. The method further includes reducing the distance between two subsequent pulses until the distance has reached the predefined minimum distance, when the distance between two subsequent pulses is not less than the predefined minimum distance, to determine whether the location of predefined MBF has reached the target location of predefined MBF and the COV of IMEP is less than the target COV of IMEP. The method further includes advancing the plasma spark time until the plasma spark time has reached the predefined maximum plasma spark time, to determine whether the location of predefined MBF has reached the target location of predefined MBF and the COV of IMEP is less than the target COV of IMEP, respectively.

Other features and aspects of this disclosure will be apparent from the following description and the accompanying drawings.

### BRIEF DESCRIPTION OF THE DRAWINGS

FIG. 1 is a schematic block diagram of a system for controlling combustion in a plasma ignition engine, according to an embodiment of the present disclosure; and

FIG. 2 is a flow chart of a method for controlling combustion in the plasma ignition engine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

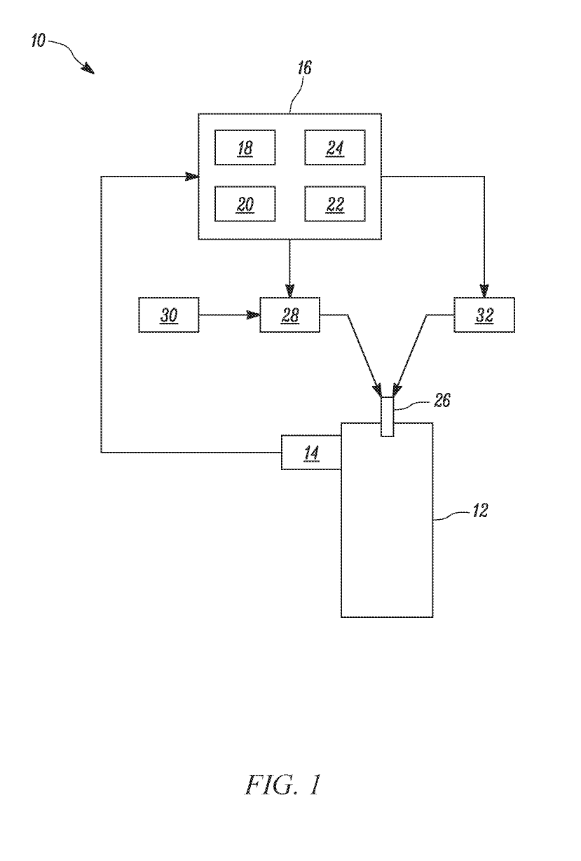

FIG. 1 illustrates a system 10 for controlling combustion in a plasma ignition engine 12, hereinafter referred to as ‘the engine 12’. The engine 12 is an internal combustion engine equipped with a plasma ignition device, such as a plasma jet spark plug. The engine 12 may either be a single cylinder engine or a multi-cylinder engine having an inline configuration, a radial configuration, or other configurations known to one skilled in the art. The engine 12 may be used in various applications, but not limited to, transportation, for example, in off-highway trucks, in earth-moving machines, or for power generation, for example, when coupled to a generator set, or to drive turbo-machines and/or other equipment such as, pumps, compressors, and other devices known in the art. The engine 12 may be adapted to operate using fuels such as, but not limited to, Gasoline, Diesel, Compressed Natural Gas (CNG), Liquefied Natural Gas (LNG,/LPG), and Bio-fuels, such as, Bio-diesel, Ethanol, Methanol, and the like. A person of ordinary skill in the art will appreciate that embodiments of the present disclosure may be implemented in various types of engines known in the art without deviating from scope of the present disclosure.

The system 10 further includes a sensing unit 14 disposed in the engine 12. The sensing unit 14 is adapted to generate a signal indicative of a cylinder pressure post a combustion stroke of the engine 12. For instance, the sensing unit 14 may include multiple sensors which are disposed in the engine 12 to generate the signal indicative of the cylinder pressure. The system 10 may also include additional sensors for generating signal indicative of various operating parameters of the engine 12 such as, inlet manifold pressure, exhaust manifold pressure of the engine 12, and fuel supply pressure.

In order to utilize the signal generated by the sensing unit 14 and to control combustion in the engine 12, the system 10 includes a control unit 16. In one example, the control unit 16 may be a processor that includes a single processing unit or a number of processing units, all of which include multiple computing units. The explicit use of the term ‘processor’ should not be construed to refer exclusively to hardware capable of executing a software application. Rather, in this example, the control unit 16 may be implemented as one or more microprocessors, microcomputers, digital signal processor, central processing units, state machine, logic circuitries, and/or any device that is capable of manipulating signals based on operational instructions. Among the capabilities mentioned herein, the control unit 16 may also be configured to receive, transmit, and execute computer-readable instructions.

The control unit 16 is configured to receive the signal generated by the sensing unit 14. On receipt of the signal from the sensing unit 14, the control unit 16 is configured to determine operational factors and control the combustion of charge in the engine 12. For the purpose of determining the operational factors, the control unit 16 includes one or more modules, such as a mass burnt fraction (MBF) and indicated mean effective pressure (IMEP) determination module 18, a pulse characteristic determination module 20, an input voltage determination module 22, and a spark timing determination module 24.

The MBF and IMEP determination module 18 is configured to receive the signal from the sensing unit 14. Further, the MBF and IMEP determination module 18 is configured to determine a location of a predefined MBF, alternatively referred to as a predefined mass fraction burnt, and a co-efficient of variance (COV) of IMEP of the engine 12, based on the cylinder pressure. Determination of the MBF indicates a rate at which heat is released while charge is combusted in the engine 12. The MBF thus determined is used as an indication of combustion phase, rate of heat release, charge dilution, or other metrics used in the control of operation of the engine 12. In particular, the determination of MBF indicates progression of combustion of the charge with respect to a crank angle of a crankshaft (not shown) of the engine 12. As such, location of the predefined MBF indicates a crank angle at which the charge is combusted to a predefined percentage. For example, the MBF and IMEP determination module 18 is configured to determine the location of 50% MBF. Further, as known to a person skilled in the art, the MBF and IMEP determination module 18 may be configured based on Rassweiler-Withrow's method of determining MBF and the location of the predefined MBF. The MBF and IMEP determination module 18 is also configured to simultaneously determine IMEP of the engine 12, based on the cylinder pressure. IMEP is a pressure in the engine 12 required to convert heat into mechanical work. On determining the IMEP, the MBF and IMEP determination module 18 is configured to determine a co-efficient of variance (COV) of the IMEP.

Further, the MBF and IMEP determination module 18 is configured to compare the determined location of the predefined MBF with a target location of the predefined MBF and determined COV of IMEP with a target COV of IMEP. In one example, the target COV of IMEP may be five percent (5%) and it is required that the determined COV of IMEP of one combustion cycle is less than the target COV of IMEP for efficient combustion of the charge in the engine 12 during a subsequent combustion cycle. Based on the comparison, the pulse characteristic determination module 20 of the control unit 16 is configured to determine whether number of pulses in a plasma shock wave is greater than a threshold number of pulses. The plasma shock wave may be understood as a power supply that is provided, in form of a wave signal, to a plasma jet injector 26 for initiating combustion in the engine 12. In an example, the wave signal of the plasma shock wave may be a square wave. As such, the wave signal defines characteristics of a wave, such as amplitude, wavelength, frequency, and period. The plasma shock wave is of an order of nanometer. That is, any of the characteristic of the wave mentioned herein may be in the order of nanometer. The phrase ‘threshold number of pulses’ may be understood as a minimum number of pulses in the plasma shock wave, required to strike a plasma spark in a cylinder of the engine 12.

For instance, the amplitude of the wave signal may be associated with a required voltage that needs to be supplied to the plasma jet injector 26 for striking the plasma spark in the cylinder of the engine 12. The wave signal is composed of a number of pulses that assist in supplying the power supply to the plasma jet injector 26. Accordingly, the threshold number of pulses in the wave signal is responsible for carrying the required voltage to the plasma jet injector 26, without which the plasma spark of a required magnitude would not struck in the cylinder of the engine 12. In such a case, the pulse characteristic determination module 20 is configured to determine whether the number of pulses in the plasma shock wave is greater than the threshold number of pulses, when the determined location of the predefined MBF has not reached the target location of the predefined MBF and the determined COV of IMEP is not less than the target COV of IMEP.

However, in cases where the determined location of the predefined MBF has reached the target location of the predefined MBF and the determined COV of IMEP is less than the target COV of IMEP, the MBF and IMEP determination module 18 of the control unit 16 receives a subsequent signal from the sensing unit 14. The subsequent signal from the sensing unit 14 corresponds to the cylinder pressure of a subsequent combustion cycle of the engine 12. Further, when the pulse characteristic determination module 20 determines that the number of pulses in the plasma shock wave is less than the threshold number of pulses, the pulse characteristic determination module 20 is configured to increase the number of pulses in the plasma shock wave. For the purpose, the system 10 includes a plasma energy supply source 28 that is in communication with the control unit 16. In one example, the plasma energy supply source 28 may be another control unit or a device that is capable of varying characteristics of the plasma shock wave, and supply power to the plasma jet injector 26 thereafter. For instance, based on input from the pulse characteristic determination module 20, the plasma energy supply source 28 may vary at least one characteristic of the wave signal, such as the amplitude or the wavelength. As such, the plasma energy supply source 28 may vary the amplitude or the wavelength of the plasma shock wave to increase the number of pulses in the plasma shock wave.

The system 10 also includes a power source 30, such as battery, to assist in operation of the plasma energy supply source 28. In other words, the plasma energy supply source 28 is in electric communication with the power source 30 so that the plasma energy supply source 28 can draw power from the power source 30 when required. When the plasma shock wave having increased number of pulses is fed to the plasma jet injector 26, the plasma spark is struck in the cylinder to combust the charge. Subsequently, the sensing unit 14 senses the cylinder pressure post combustion and generates the signal indicative of the cylinder pressure. Further, as described above, the control unit 16 receives the signal from the sensing unit 14. Based on the cylinder pressure, the MBF and IMEP determination module 18 determines whether the location of the predefined MBF has reached the target location of the predefined MBF and the COV of IMEP is less than the target COV of IMEP. Accordingly, until such a condition is satisfied, the pulse characteristic determination module 20 varies the characteristic of the plasma shock wave to increase the number of pulses.

In cases where the pulse characteristic determination module 20 determines that the number of pulses in the plasma shock wave is greater than the threshold number of pulses, the pulse characteristic determination module 20 activates the input voltage determination module 22. Like the pulse characteristic determination module 20, the input voltage determination module 22 is also in electric communication with the plasma energy supply source 28. On being activated by the pulse characteristic determination module 20, the input voltage determination module 22 determines whether an input voltage associated with the plasma shock wave is greater than a predefined minimum voltage. The predefined minimum voltage may be understood as a minimum voltage required for striking the plasma spark of required magnitude.

With the aid of the plasma energy supply source 28, the input voltage determination module 22 is configured to increase the input voltage associated with the plasma shock wave, when the input voltage is less than the predefined minimum voltage. Further, when the plasma shock wave having increased voltage is fed to the plasma jet injector 26, the plasma spark is struck in the cylinder to combust the charge. Subsequently, the sensing unit 14 senses the cylinder pressure post combustion and generates the signal indicative of the cylinder pressure. Based on the cylinder pressure, the MBF and IMEP determination module 18 determines whether the location of the predefined MBF has reached the target location of the predefined MBF and the COV of IMEP is less than the target COV of IMEP. Accordingly, until such a condition is satisfied, the input voltage determination module 22 increases voltage of the plasma shock wave. However, when the input voltage determination module 22 determines that the input voltage associated with the plasma shock wave is greater than the predefined minimum voltage, the input voltage determination module 22 sends feedback to the pulse characteristic determination module 20.

Thereafter, the pulse characteristic determination module 20 determines whether a distance between two subsequent pulses in the plasma shock wave is less than a predefined minimum distance. The predefined minimum distance of the plasma shock wave indicates strength of the wave signal. For example, when the distance between two subsequent pulses, or pulse separation, is greater than a threshold value, the wave signal is considered to have less strength. That is, the distance between two subsequent pulses is large, thereby having minimum number of pulses in a given wavelength. In other words, number of crests and troughs of the plasma shock wave are less in the given wavelength, thereby rendering the plasma wave shock less strong.

Accordingly, when the distance between two subsequent pulses of the plasma shock wave is not less than the predefined minimum distance, the pulse characteristic determination module 20 is configured to reduce the distance between two subsequent pulses until the distance has reached the predefined minimum distance. It will be understood that the task of reducing the distance between two subsequent pulses of the plasma shock wave would be performed by the plasma energy supply source 28, based on inputs from the pulse characteristic determination module 20. Subsequently, as described above, the MBF and IMEP determination module 18 determines whether the location of the predefined MBF has reached the target location of the predefined MBF and the COV of IMEP is less than the target COV of IMEP as an effect of reducing the distance between two subsequent pulses.

However, when the distance between two subsequent pulses is less than the predefined minimum distance, the pulse characteristic determination module 20 activates the spark timing determination module 24. On such activation, the spark timing determination module 24 is configured to determine whether a plasma spark time is greater than a predefined maximum plasma spark time. The phrase ‘plasma spark time’ may be understood as a crank angle at which the plasma spark is struck in the cylinder of the engine 12. Generally, the plasma spark is struck at a crank angle in the cylinder before a piston of the engine 12 reaches a top dead center (TDC). As such, maximum crank angle before the TDC may be understood as the predefined maximum plasma spark time.

When the plasma spark time is not greater than the predefined maximum plasma spark time, the spark timing determination module 24 is configured to advance the plasma spark time until the plasma spark time has reached the predefined maximum plasma spark time. For example, if the plasma spark time is 7 degrees before TDC and the predefined maximum plasma spark time is about 20 degrees, spark timing determination module 24 increases the plasma spark timing, that is towards 20 degrees. In one example, after advancement of the plasma spark time, the sensing unit 14 may sense the cylinder pressure and the MBF and IMEP determination module 18 may determine whether the location of the predefined MBF has reached the target location of the predefined MBF and the COV of IMEP is less than the target COV of IMEP. The system 10 further includes a distributor 32 that is electrically coupled to the plasma jet injector 26. The distributor 32 is also coupled to the spark timing determination module 24 to aid in advancing the plasma spark timing.

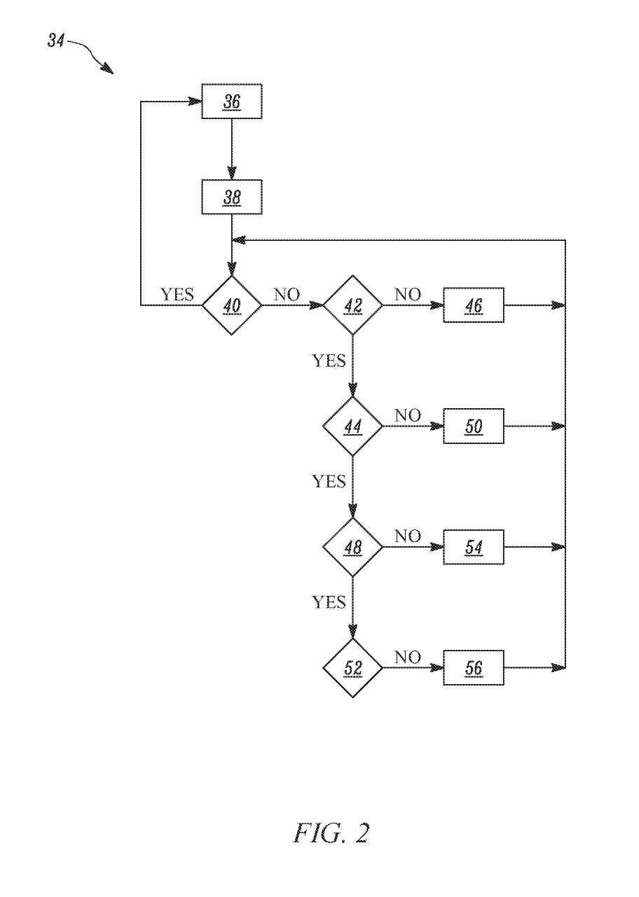

FIG. 2 illustrates a flow chart of a method 34 for controlling combustion in the engine 12. The method 34 may be implemented in any suitable hardware, such that the hardware employed can perform steps of the method 34 readily and on a real-time basis. For example, the method 34 may be implemented by the control unit 16.

For the purpose of description, various steps of the method 34 are described in conjunction with FIG. 1 of the present disclosure. At step 36, the method 34 includes receiving, from the sensing unit 14, the signal indicative of the cylinder pressure. The sensing unit 14 is disposed in the engine 12. At step 38, the method 34 includes determining, by the control unit 16, the location of the predefined MBF and COV of IMEP based on the cylinder pressure. The control unit 16 is in communication with the sensing unit 14 for receiving the signal. At step 40, the method 34 includes comparing, by the control unit 16, the determined location of the predefined MBF with the target location of the predefined MBF and the determined COV of IMEP with the target COV of IMEP. The target location of the predefined MBF and the target COV of IMEP may be fed into the control unit 16 and may be stored in a memory module of the control unit 16.

When the location of the predefined MBF has reached the target location of the predefined MBF and the COV of IMEP is less than the target COV of IMEP, the method 34 branches into a ‘Yes’ branch from step 40. Further, the ‘Yes’ from step 40 leads the method 34 to the step 36 to receive cylinder pressure of the subsequent combustion cycle of the engine 12. However, when the location of the predefined MBF has not reached the target location of the predefined MBF and the COV of IMEP is not less than the target COV of IMEP, the method 34 branches to a ‘No’ branch leading into step 42.

At the step 42, the method 34 includes determining whether number of pulses in the plasma shock wave is greater than the threshold number of pulses. When the number of pulses in the plasma shock wave is greater than the threshold number of pulses at step 42, the method 34 branches to a ‘Yes’ branch leading into step 44. However, when the number of pulses in the plasma shock wave is less than the threshold number of pulses at step 42, the method 34 branches to a ‘No’ branch and into a step 46.

At step 44, the method 34 includes determining whether the input voltage associated with the plasma shock wave is greater than the predefined minimum voltage. At step 46, the method 34 includes increasing the number of pulses in the plasma shock wave. Further, the method 34 returns to step 40 after step 46, to determine whether the location of predefined MBF has reached the target location of the predefined MBF and the COV of IMEP is less than the target COV of IMEP.

When the input voltage associated with the plasma shock wave is greater than the predefined minimum voltage at step 44, the method 34 branches into a ‘Yes’ branch leading to step 48. When the input voltage associated with the plasma shock wave is not greater than the predefined minimum voltage at step 44, the method 34 branches into a ‘No’ branch leading to step 50.

At step 48, the method 34 includes determining whether the distance between two subsequent pulses is less than the predefined minimum distance. At step 50, the method 34 includes increasing the input voltage associated with the plasma shock wave. Further, the method 34 returns to step 40 after step 46, to determine whether the location of the predefined MBF has reached the target location of the predefined MBF and the COV of IMEP is less than the target COV of IMEP. When the distance between two subsequent pulses is less than the predefined minimum distance, the method 34 branches into a ‘Yes’ branch leading to step 52. However, when the distance between two subsequent pulses is not less than the predefined minimum distance, the method 34 branches into a ‘No’ branch from step 48 to step 54.

At step 52, the method 34 includes determining whether the plasma spark time is greater than the predefined maximum plasma spark time. At step 54, the method 34 includes reducing the distance between two subsequent pulses until the distance has reached the predefined minimum distance. Further, the method 34 returns to step 40 after step 54, to determine whether the location of predefined MBF has reached the target location of the predefined MBF and the COV of IMEP is less than the target COV of IMEP. Further, when the plasma spark time is not greater than the predefined maximum plasma spark time, the method 34 branches into a ‘No’ branch leading to step 56. At step 56, the method 34 includes advancing the plasma spark time until the plasma spark time has reached the predefined maximum plasma spark time. Further, the method 34 returns to step 40 after step 56, to determine whether the location of predefined MBF has reached the target location of the predefined MBF and the COV of IMEP is less than the target COV of IMEP.

Various embodiments disclosed herein are to be taken in the illustrative and explanatory sense, and should in no way be construed as limiting of the present disclosure.

### INDUSTRIAL APPLICABILITY

The present disclosure relates to the system 10 and the method 34 for controlling combustion in the engine 12. As describes above with reference to FIG. 1 and FIG. 2, the present disclosure describes the manner in which plasma energy supply can be controlled to achieve optimum combustion over a wide range of operating conditions of the engine 12. Further, since the sensing unit 14 senses the cylinder pressure after every combustion cycle, the control unit 16 controls the plasma energy supply to the plasma jet injector 26 on a real-time basis. Owing to such controlled supply of plasma energy, life of the plasma jet injector 26 is increased, thereby extending service intervals. In addition, since the present disclosure also considers IMEP of the engine 12, the system 10 and the method 34 help in achieving enhanced thermal efficiency, which was otherwise low.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for controlling combustion in a plasma ignition engine, the method comprising:
receiving, from a sensing unit, a signal indicative of a cylinder pressure, the sensing unit being disposed in the plasma ignition engine;
determining, by a control unit, a location of predefined mass burnt fraction (MBF) and co-efficient of variance (COV) of indicated mean effective pressure (IMEP) based on the cylinder pressure;
comparing, by the control unit, the determined location of predefined MBF with a target location of predefined MBF and the determined COV of IMEP with a target COV of IMEP;
determining whether number of pulses in a plasma shock wave is greater than a threshold number of pulses, when the determined location of predefined MBF has not reached the target location of predefined MBF and the determined COV of IMEP is not less than the target COV of IMEP, wherein the plasma shock wave is of an order of nanometer;
receiving, from the sensing unit, the cylinder pressure of a subsequent operation cycle, when the determined location of predefined MBF has reached the target location of predefined MBF and the determined COV of IMEP is less than the target COV of IMEP;
determining whether an input voltage associated with the plasma shock wave is greater than a predefined minimum voltage, when the number of pulses in the plasma shock wave is greater than the threshold number of pulses;
increasing the number of pulses in the plasma shock wave, when the number of pulses is less than the threshold number of pulses, to determine whether the location of predefined MBF has reached the target location of predefined MBF and the COV of IMEP is less than the target COV of IMEP;
determining whether a distance between two subsequent pulses is less than a predefined minimum distance, when the input voltage associated with the plasma shock wave is greater than the predefined minimum voltage;
increasing the input voltage associated with the plasma shock wave, when the input voltage is less than the predefined minimum voltage, to determine whether the location of predefined MBF has reached the target location of predefined MBF and the COV of IMEP is less than the target COV of IMEP;
determining whether a plasma spark time is greater than a predefined maximum plasma spark time, when the distance between two subsequent pulses is less than the predefined minimum distance;
reducing the distance between two subsequent pulses until the distance has reached the predefined minimum distance, when the distance between two subsequent pulses is not less than the predefined minimum distance, to determine whether the location of predefined MBF has reached the target location of predefined MBF and the COV of IMEP is less than the target COV of IMEP; and
advancing the plasma spark time until the plasma spark time has reached the predefined maximum plasma spark time, to determine whether the location of predefined MBF has reached the target location of predefined MBF and the COV of IMEP is less than the target COV of IMEP, when the plasma spark time is not greater than the predefined maximum plasma spark time.
